(19) United States
(12) Patent Application Publication
(10) Pub. No.: US 2005/0015260 A1
(43) Pub. Date: Jan. 20, 2005

(54) MP3 application device

(76) Inventors: Ching-Fu Hung, Hsinchu-City (TW); Kung-Wang Lee, Jhubei City (TW); Shih-Chou Juan, Jhongli City (TW)

Correspondence Address: J.C. Patents, Inc., Suite 250, 4 Venture, Irvine, CA, 92618, US

(21) Appl. No.: 10/658,127

(22) Filed: Sep. 8, 2003

(30) Foreign Application Priority Data
Jul. 15, 2003 (TW) 92119225

(51) Int. Cl. G10L 19/00

(52) U.S. Cl. 704/500

(57) ABSTRACT

An MP3 application device is provided. The MP3 application device comprises a host interface module, a playing module and a loudspeaker or a frequency modulation transmitter. Furthermore, a universal serial bus (USB) device or a memory card can be plugged into the MP3 application device. In this invention, the playing module issues a fetch instruction to read MP3 code data from the USB device or the memory card. An MP3 decoder with the playing module decodes the MP3 code data into voice data. The voice data is transmitted to the loudspeaker and broadcast. Alternatively, the voice data is sent to the frequency modulation transmitter and transmitted as wireless signals.

### CROSS-REFERENCE TO RELATED APPLICATION

This application claims the priority benefit of Taiwan application serial no. 92119225, filed Jul. 15, 2003.

### BACKGROUND OF THE INVENTION

1. Field of the Invention

The present invention relates to an MP3 playing device. More particularly, the present invention relates to an MP3 application device capable of playing music by reading MP3 code data stored inside a portable disk or a memory card without a computer or an MP3 audio system.

2. Description of the Related Art

With rapid advance in personal computer technologies and networking interfaces, downloading music in various digital format such as MP3 (MPEG layer 3) MIDI (Musical Instrument Digital Interface), WAV and WMA is quite common. After downloading, the music is played through a computer. In fact, WAV and WMA are Window software catered for the audio frequency format. With recent legalization of MP3 data downloading, more people choose to download MP3 audio files due to their higher sound quality, small data volume and ease of acquisition. Furthermore, as the prices of portable disks fall, more people choose to hold MP3 song data in portable disks so that to exchange MP3 data with friends easily.

In general, people can listen to MP3 songs at home by switching on a computer and inside a car if an MP3 decoder system is installed. If the purpose of switching the computer on is to listen to MP3 songs, both power and computer resources are wasted. Moreover, the computer needs time to perform a list of tests before the operating system is ready. On the other hand, listening to MP3 music inside a car requires installation of an MP3 system instead of a CD audio system. In other words, MP3 users have to spend a sum of money to replace the ordinary CD system with an MP3 system before they can play their favorite MP3 songs burned on a CD inside their car.

In brief, MP3 songs can be listened to at home by turning the computer on and inside a car by installing a CD system with an MP3 decoder. Yet, solely listening to MP3 music via the computer is a heavy waste of energy and installing an MP3 decoder in a car is a burden to the user.

### SUMMARY OF THE INVENTION

Accordingly, one object of the present invention is to provide an application device for MP3 such that MP3 data stored in a Universal Serial Bus (USB) device or a memory card can be directly played on a loudspeaker without a computer.

A second object of this invention is to provide an application device for MP3 that utilizes the standard frequency modulation (FM) stereo-audio system within a car to play MP3 audio data inside a USB device or a memory card.

To achieve these and other advantages and in accordance with the purpose of the invention, as embodied and broadly described herein, the invention provides an application device for playing MP3 music. The application device is connected to a USB device or a memory card so that MP3 code data stored within the USB device or the memory card can be played. The MP3 application device further comprises a loudspeaker, a host interface module and a playing module.

According to one preferred embodiment of this invention, the host interface module comprises a universal serial bus (USB) host circuit and a card host circuit. The USB host circuit is an interface for communicating with the USB device. The card host circuit is an interface for communicating with the memory card when a memory card is plugged into the MP3 application device.

According to the preferred embodiment of this invention, the playing module actively issues a fetch instruction via the host interface module and then reads the MP3 code data from the USB device. The playing module comprises an MP3 decoder, a buffer unit and a host unit. The buffer unit is a place for holding the MP3 code data temporarily. The MP3 decoder converts the MP3 code data within the buffer unit into voice data and then outputs the voice data. The host unit is a controller for controlling the host interface module, the buffer unit and the MP3 decoder.

According to one preferred embodiment of this invention, the loudspeaker receives and broadcasts the voice data.

This invention also provides an MP3 application device. The MP3 application device can be used to play MP3 code data read from a USB device inside a car equipped with a car audio-stereo system but without any MP3 playing function. The MP3 application device comprises a host interface module, a playing module and a frequency modulation transmitter. Furthermore, the car audio-stereo system comprises a frequency modulation receiver.

According to the preferred embodiment of this invention, the host interface module further comprises a USB host circuit and a card host circuit. The USB host circuit is an interface for communicating with the USB device. The card host circuit is an interface for communicating with the memory card when the memory card is plugged into the MP3 application device.

According to one preferred embodiment of this invention, the playing module actively issues the fetch instruction via the host interface module and then reads MP3 code data from the USB device. The playing module comprises an MP3 decoder, a buffer unit and a host unit. The buffer unit is a place for holding the MP3 code data temporarily. The MP3 decoder converts the MP3 code data within the buffer unit into voice data and then outputs the voice data. The host unit is a controller for controlling the host interface module, the buffer unit and the MP3 decoder.

According to the preferred embodiment of this invention, the frequency modulation transmitter converts the voice data from the MP3 decoder into wireless signals and then transmits the wireless signals.

According to the preferred embodiment of this invention, the voice data is played when the frequency modulation receiver of a car audio-stereo system receives the wireless signals.

According to one preferred embodiment of this invention, the MP3 application device further comprises a voltage transformer for supplying power to various circuits within the MP3.

In this invention, a USB host terminal or a card host terminal is set up in the loudspeaker. Hence, MP3 audio data stored inside a portable disk or a memory card can be directly read and played via the application device instead of being relayed through a computer.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the circuit components of an MP3 application device according to one preferred embodiment of this invention.

FIG. 2 is a block diagram showing the circuit components of an alternative MP3 application device according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

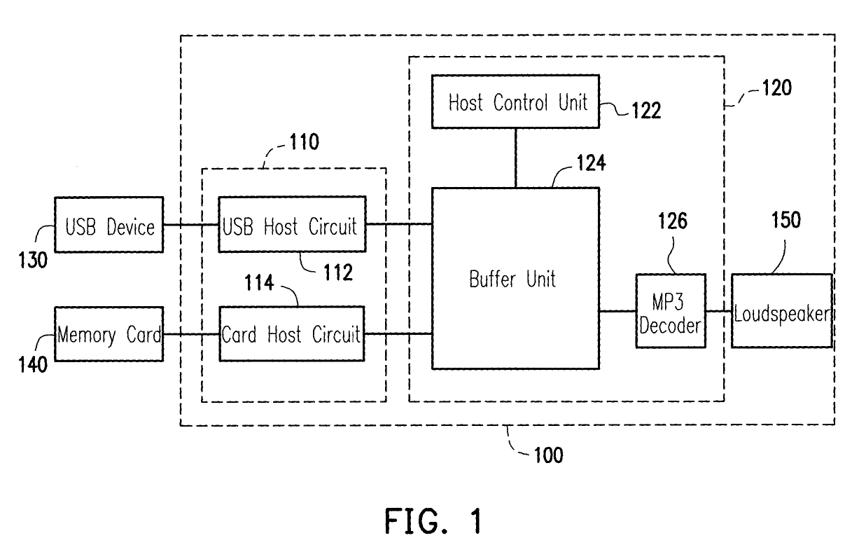

FIG. 1 is a block diagram showing the circuit components of an MP3 application device according to one preferred embodiment of this invention. In this embodiment, a Universal Serial Bus (USB) device 130 or a memory card 140 can be plugged into the MP3 application device 100. The USB device 130 can be a portable disk, for example. The memory card 140 can be a data storage card including, for example, a Compact Flash (CF) card, a Smart Media (SM) card, a Secure Digital (SD) card, a Memory Stick (MS) or a Multi-Media Card (MMC).

As shown in FIG. 1, the MP3 application device 100 comprises a host interface module 110, a playing module 120 and a loudspeaker 150. The playing module 120 is coupled to the host interface module 110 and the loudspeaker 150. The host interface module 110 serves as an interface for communicating with a USB device 130 or a memory card 140. The playing module 120 issues a fetch instruction via the host interface module 110 to read MP3 code data from the USB device 130 or the memory card 140. After decoding the MP3 code data, voice data is output to the loudspeaker 150.

In this embodiment, the host interface module 110 further comprises a Universal Serial Bus (USB) host circuit 112 and a card host circuit 114. The USB host circuit 112 serves as an interface between the MP3 application device 100 and the USB device 130. Similarly, the card host circuit 140 serves as an interface between the MP3 application device 100 and the memory card 140.

The playing module 120 further comprises a host control unit 122, a buffer unit 124 and an MP3 decoder 126. The buffer unit 124 is coupled to the host interface module 110, the host control unit 122 and the MP3 decoder 126. The host control unit 122 controls the host interface module 110, the buffer unit 124 and the MP3 decoder 126. The buffer unit 124 is a place for holding the MP3 code data read out from the USB device 130 or the memory card 140 temporarily. The MP3 decoder 126 converts the MP3 code data within the buffer unit 124 into voice data and transmits the voice data to the loudspeaker 150 for broadcasting.

In this embodiment, the MP3 application device 100 is activated when the host control unit 122 actively issues a fetch instruction via the host interface module 110. Thereafter, MP3 code data is read from the USB device 130 or the memory card 140 and relayed to the buffer unit 124 for temporary storage via the host interface module 110. The MP3 decoder 126 decodes the MP3 code data to produce voice data. Finally, the voice data is transmitted to the loudspeaker 150 for broadcasting.

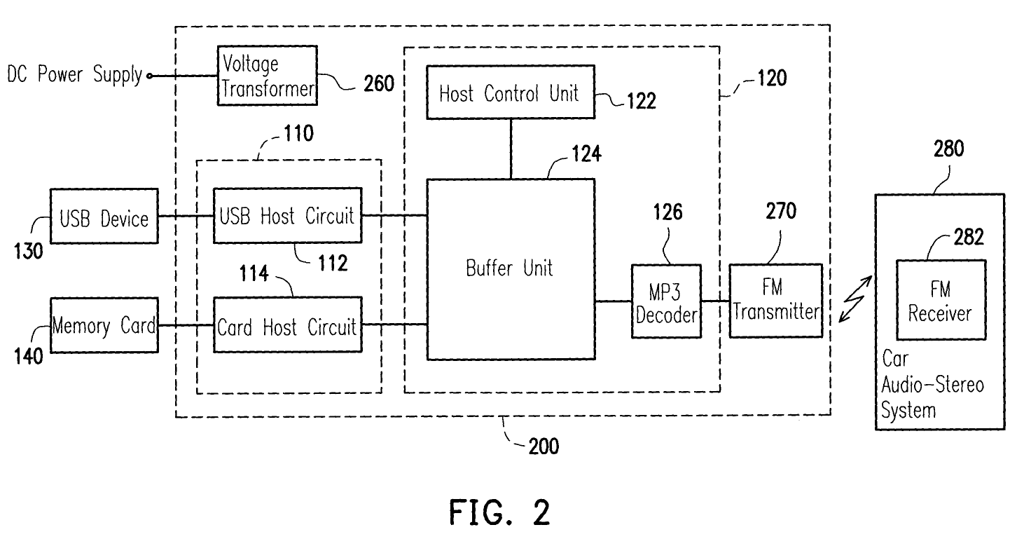

FIG. 2 is a block diagram showing the circuit components of an alternative MP3 application device according to one preferred embodiment of this invention. In this embodiment, the MP3 application device 200 reads MP3 code data from a universal serial bus (USB) device 130 or a memory card 140 and plays through the frequency modulation (FM) receiver 282 of a car audio-stereo system. The MP3 application device may also receive power from the standard 12V DC power outlet inside each car.

The MP3 application device 200 further comprises a host interface module 110, a playing module 120 and a frequency modulation (FM) transmitter 270. The playing module 120 is coupled to the host interface module 110 and the frequency modulation transmitter 270. The host interface module 110 serves as an interface for communication with the USB bus 130 or the memory card 140. The playing module 120 issues a fetch instruction via the host interface module 110 to read MP3 code data from the USB device 130 or the memory card 140. Thereafter, the MP3 code data is decoded to output voice data. The frequency modulation transmitter 270 converts the voice data into wireless signals and then transmits the wireless signals.

The main difference between the MP3 application device 100 in FIG. 1 and the MP3 application device 200 in FIG. 2 is that the MP3 decoder 126 in FIG. 2 transmits voice data to a frequency modulation transmitter 270. After some processing treatment, the frequency modulation transmitter 270 transmits wireless signals containing voice data. Other difference includes a voltage transformer 260 for receiving the DC power (12V) from the cigar lighter and converting the voltage to a suitable level for supplying power to various components inside the device 200.

After transmitting the wireless signals carrying voice data is transmitted via the frequency modulation transmitter 270, a frequency modulation receiver 282 within the car audio-stereo system picks up the signals. After some processing treatment, the voice data is broadcast inside the car.

In this embodiment, the MP3 application device 200 is activated when the host control unit 122 actively issues a fetch instruction via the host interface module 110. Thereafter, MP3 code data is read from the USB device 130 or the memory card 140 and relayed to the buffer unit 124 for temporary storage via the host interface module 110. The MP3 decoder 126 decodes the MP3 code data to produce voice data. The frequency modulation transmitter 270 converts the voice data into wireless signals and then the signals are transmitted. The frequency modulation receiver 282 receives the wireless signals and broadcast the voice data after some internal processing.

In this embodiment, the voltage transformer 260 can be a dc/dc voltage transformer, for example. Furthermore, if the MP3 application device 200 incorporates a large storage capacity device (not shown), the device 200 can read a large volume of MP3 code data from the USB device 130 or the memory card 140. Hence, the MP3 application device 200 may broadcast MP3 code data directly from the large storage capacity device.

In summary, major advantages of the MP3 application device according to this invention includes:
1. MP3 audio data stored inside a portable disk or a memory card can be played directly without being relayed through a computer.
2. The frequency modulation receiver inside a car can be used to play MP3 audio data stored in a portable disk or a memory card.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An MP3 application device for playing MP3 code data read from a universal serial bus (USB) device, comprising:
a host interface module with a universal serial bus (USB) host circuit serving as an interface for communicating with the USB device;
a playing module coupled to the host interface module, wherein the playing module further comprises an MP3 decoder for converting the MP3 code data into voice data and the playing module actively issues a read instruction via the host interface module to read the MP3 code data from the USB device; and
a loudspeaker coupled to the playing module for receiving and broadcasting the voice data.

2. The MP3 application device of claim 1, wherein the application device further comprises reading the MP3 code data from a memory card.

3. The MP3 application device of claim 2, wherein the host interface module further comprises a card host circuit serving as an interface for communicating with the memory card.

4. The MP3 application device of claim 1, wherein the playing module further comprises:
a buffer unit coupled to the host interface module and the MP3 decoder for holding the MP3 code data temporarily; and
a host control unit for controlling the host interface module, the buffer unit and the MP3 decoder.

5. The MP3 application device as recited in claim 1, wherein the USB device comprises a portable disk.

6. An MP3 application device for reading MP3 code data from a universal serial bus (USB) device, comprising:
a host interface module with a universal serial bus (USB) host circuit serving as an interface for communicating with the USB device;
a playing module coupled to the host interface module, wherein the playing module further comprises an MP3 decoder for converting the MP3 code data into voice data and the playing module actively issues a read instruction via the host interface module to read the MP3 code data from the USB device; and
a frequency modulation transmitter coupled to the MP3 decoder for transmitting a wireless signal carrying the voice data.

7. The MP3 application device of claim 6, wherein the wireless signal is intercepted by a frequency modulation receiver.

8. The MP3 application device of claim 7, wherein the frequency modulation receiver for receiving and playing the voice data is part of a car audio-stereo system.

9. The MP3 application device of claim 6, wherein the application device further comprises reading the MP3 code data from a memory card.

10. The MP3 application device of claim 9, wherein the host interface module further comprises a card host circuit serving as an interface for communicating with the memory card.

11. The MP3 application device of claim 6, wherein the playing module further comprises:
a buffer unit coupled to the host interface module and the MP3 decoder for holding the MP3 code data temporarily; and
a host control unit for controlling the host interface module, the buffer unit and the MP3 decoder.

12. The MP3 application device of claim 6, wherein the application device further comprises a voltage transformer coupled to a direct current power source for supplying power to electrical components in the MP3 application device.

13. The MP3 application device of claim 6, wherein the USB device comprises a portable disk.
